(19) United States
(12) Patent Application Publication
(10) Pub. No.: US 2016/0135395 A1
(43) Pub. Date: May 19, 2016

(54) MODULAR HYDROPONIC GROWING SYSTEM

(71) Applicant: Neil Umpstead, San Diego, CA (US)

(72) Inventor: Neil Umpstead, San Diego, CA (US)

(21) Appl. No.: 14/699,222

(22) Filed: Apr. 29, 2015

Related U.S. Application Data
(60) Provisional application No. 62/081,282, filed on Nov. 18, 2014.

(51) Int. Cl. A01G 31/02

(52) U.S. Cl. CPC A01G 31/02

(57) ABSTRACT

A hydroponic system has multiple interconnecting components, including a reservoir, a manifold that fills and drains the hydroponic system, a trunk that extends from the manifold, one or more branches that extend from the trunk, end caps that close the ends of the trunk and the branches, and optionally, extension sections for both the trunk and the branches. The trunk and the branches are constructed from a plurality of tubular sections that interconnect with one another using a levered locking system. An air line is integrated into an interior wall of the manifold and the trunk, and extends from the manifold through the trunk. The system is constructed of pre-assembled components, making it easy for a user to accommodate any size space. The modularity and interconnectivity of the system allows a user to easily and quickly perform maintenance and repairs without the use of tools.

### CROSS-REFERENCE TO RELATED APPLICATION

The present application claims priority to U.S. Provisional Patent Application No. 62/081,282 filed on Nov. 18, 2014, entitled “MODULAR HYDROPONIC GROWING SYSTEM, KIT, AND METHOD OF ASSEMBLY”, the entire disclosure of which is incorporated by reference herein.

### BACKGROUND OF THE INVENTION

1. Field of the Invention

The present invention relates generally to hydroponic growing systems. More specifically, it relates to an interconnecting modular hydroponic growing system.

2. Description of Related Art

In traditional art, one of the most popular hydroponic growing techniques is the flood and drain sub-irrigation technique, also known as the “ebb and flow” system, wherein a tray sits above a reservoir of nutrient solution. In an ebb and flow system, either the tray is filled with growing medium (e.g., clay granules) and plants are placed directly into the tray, or plants can be placed in pots standing in the tray that are filled with medium. At regular intervals, a timer causes a pump to fill the tray with a nutrient solution, then the solution drains back down into the reservoir. This keeps the medium regularly flushed with nutrients and air. Once the tray fills past the drain stop, it begins re-circulating the water until the timer turns the pump off, and the water in the tray drains back into the reservoirs.

There are several drawbacks in the current hydroponics industry regarding ebb and flow systems. First of all, the ebb and flow systems in the art today are inefficient in their use of water and nutrients in solution (typically, about 120 gallons are used for an 8×8 ft. area). Because nutrients can be expensive, minimizing the volume of water used is beneficial. Another disadvantage of current ebb and flow systems is that since they require the use of a tray or large containers, they are limited in the ways they can be configured to fit a space. In addition, it is difficult or impossible to find a hydroponic kit that includes easy-to-assemble parts made specifically for that use. It is largely up to a user to design and build the system, which includes finding the right parts, including PVC pipes and fittings that must be modified by measuring and cutting in order for the system to work properly. As an example, fill and drain sections used for ebb and flow systems must be constructing using various sections, and commonly leak if built by hand. Due to the multiple parts and connections, there are many possibilities for breakdown and failure to these areas over time. This could cause leaks and damage to property around the growing area.

Another technique currently used is the nutrient film technique (NFT). In this system, a shallow stream of nutrient solution flows downward through tubing and is re-circulated past the bare roots of plants. The roots of the plants come in contact with either the nutrient solution or a watertight root mat, from which the roots absorb nutrients. A properly designed NFT system requires the right channel slope, flow rate, and channel length. Although, overall, it is probably one of the more productive techniques, one disadvantage of NFT is that it has very little buffering against interruptions in the flow, a particular concern with power outages. The plants will begin to wilt very quickly when water stops flowing through the system. Therefore, NFT systems are best suited for, and most commonly used for, growing smaller plants like varieties of lettuce.

Other hydroponic systems in the art include drip systems, water culture, aeroponics, and wick. In drip systems, a nutrient solution is pumped up from the reservoir through tubing and drips out of the tubing onto the top of the growing media (where the plant roots are), soaking both the roots and growing media all the way to the bottom of the container. From there the nutrient solution flows through an opening, and gravity allows the nutrient solution to flow downhill through tubing all the way back to the reservoir. Drip systems use a tray that needs to be at a distance above the top of the reservoir so that gravity can drain the excess water back into it. As a result, the flexibility of designing drip systems to fit into a space is limited. Water culture systems can be expensive and complicated to use, as it requires the use of air stones, air hoses, and air pumps to get the right amount of oxygen to the plant in order to maintain a high yield. Also, since the plants are suspended in baskets right above the nutrient solution in the reservoir, there is no way to re-design the configuration of the system to fit any available space. Aeroponic systems are disadvantageous, as they are expensive to build, they have mister/sprinkler heads that are susceptible to clogging, the plant roots are much more vulnerable to drying out if there is any interruption in the watering cycle, and there's a reduced margin for error with the nutrient levels, especially with the true high pressure systems. Regarding wick systems, a disadvantage is that they do not work well for larger plants that require more water. Similar to NFT systems, wick systems are more suited to grow smaller non-fruiting plants, like lettuce and herbs. Other disadvantages of wick systems include being less efficient at delivering nutrients, the inability to absorb nutrients and water evenly, and the possibility of a toxic buildup of mineral salts in the growing media.

Finally, in existing systems, there is frequently a conflict between the supply of water, oxygen and/or nutrients, since excessive or deficient amounts of one of the aforementioned components results in an imbalance of one or both of the others.

Based on the foregoing, there is a need for an inexpensive, interconnecting modular hydroponic growing system that can be made available in a kit with easy-to-assemble parts uniquely manufactured to be used specifically for this hydroponic system, wherein the parts can be easily configured to fit into any available space. There is also a need for a system that reduces nutrient costs, labor, and weight of the system by both, maximizing the use of space and using less materials and water or solution.

### SUMMARY OF THE INVENTION

A modular hydroponic system has a reservoir; a manifold connected to the reservoir; a trunk connected to the manifold at a first end of the trunk; and one or more branches connected to the trunk. The manifold is connected to a first end of the trunk, and is responsible for filling and draining the hydroponic system. The trunk has one or more T-fitting sections and an end cap connected at a second end of the trunk. The one or more branches are made of one or more receptacle sections and one or more end caps connected to a second end of the one or more branches. The one or more end caps close the second end of each branch.

In an embodiment, the modular hydroponic system also has an air line that is integrated into an interior wall of the manifold and the trunk. In a further embodiment, the air line also has an extension that extends toward each of the branches. In yet a further embodiment, an aeration device such as an air diffuser or an air stone is connected to the air line extension.

In an embodiment, the modular hydroponic system also has one or more receptacles removably inserted into the one or more receptacle sections.

In an embodiment, the trunk also has one or more trunk extension sections with two open ends for extending the trunk.

In an embodiment, the one or more branches also have one or more branch extension sections with two open ends for extending the one or more branches.

In an embodiment, each receptacle section has a fin that is upwardly disposed from the interior bottom surface of the receptacle section.

In an embodiment, the manifold, the trunk, each of the branches and each of the branch extensions are connected by fastener systems. Each fastener system has a gasket positioned between each pair of abutting sections/components, and two or more locking levers. The locking levers are positioned on opposite sides of each of the sections/components. Each locking lever has a handle and a latch arm. The handle engages with the latch arm to pull it closed as the handle is pushed against the respective section/component. A first end of the trunk and a first end of the one or more branches have two or more connection points adjacent thereto. Each connection point has an aperture that the locking lever handle connects to. The second end of the trunk and the second end of the one or more branches have two or more protrusions adjacent thereto that a catch at an end of the latch arm hooks on to. When joined by the locking levers, the abutting tubes are sealingly engaged.

In an embodiment, a cross section of the manifold, the trunk, and the one or more branches is oval.

In an embodiment, the modular hydroponic system is supported by a modular stand. The stand has at least two bases; at least two height-adjustable legs extending upwardly from the at least two bases; and a lateral support beam releasably connected to a top of the at least two legs. The lateral support beam has one ore more support sections, each of which has a recessed groove on a top surface, a vertical channel on a first end, and a protrusion on a second end. The protrusion of one section engages with the vertical channel of an adjoining section to connect the sections together.

In an alternative embodiment of the modular hydroponic system, the manifold is replaced by a hose connection assembly. A hose extends from the reservoir and is connected to one end of the hose connection assembly. At its opposite end, the hose connection assembly is connected to the first end of the trunk and fills the hydroponic system with water and/or nutrient solution. The first end of each branch is more elevated than the second end, such that each branch is downwardly sloped from the first end to the second end. The second end of each branch is open and in fluid communication with the reservoir.

### BRIEF DESCRIPTION OF THE FIGURES

For a more complete understanding of the present invention, the objects and advantages thereof, reference is now made to the ensuing descriptions taken in connection with the accompanying drawings briefly described as follows.

FIG. 1 is a perspective view of a modular hydroponic growing system, according to one embodiment of the present invention;

FIG. 2a is a perspective view of a receptacle section of the modular hydroponic growing system, according to one embodiment of the present invention;

FIG. 2b is a side elevation view of a receptacle section of the modular hydroponic growing system, according to one embodiment of the present invention;

FIG. 2c is a top plan view of a receptacle section of the modular hydroponic growing system, according to one embodiment of the present invention;

FIG. 2d is a side elevation view of a receptacle section of the modular hydroponic growing system, according to one embodiment of the present invention;

FIG. 3a is a perspective view of a receptacle of the modular hydroponic growing system, according to one embodiment of the present invention;

FIG. 3b is a side elevation view of a receptacle of the modular hydroponic growing system, according to one embodiment of the present invention;

FIG. 4a is a perspective view of a receptacle cover of the modular hydroponic growing system, according to one embodiment of the present invention;

FIG. 4b is a top plan view of a receptacle cover of the modular hydroponic growing system, according to one embodiment of the present invention;

FIG. 4c is a side elevation view of a receptacle cover of the modular hydroponic growing system, according to one embodiment of the present invention;

FIG. 5a is a perspective view of a T-fitting section of the modular hydroponic growing system, according to one embodiment of the present invention;

FIG. 5b is a top plan view of a T-fitting section of the modular hydroponic growing system, according to one embodiment of the present invention;

FIG. 5c is a front elevation view of a T-fitting section of the modular hydroponic growing system, according to one embodiment of the present invention;

FIG. 5d is a side elevation view of a T-fitting section of the modular hydroponic growing system, according to one embodiment of the present invention;

FIG. 6a is a perspective view of a extension section of the modular hydroponic growing system, according to one embodiment of the present invention;

FIG. 6b is a side elevation view of an extension section of the modular hydroponic growing system, according to one embodiment of the present invention;

FIG. 7a is a perspective view of an end cap of the modular hydroponic growing system, according to one embodiment of the present invention;

FIG. 7b is a perspective view of an end cap of the modular hydroponic growing system, according to one embodiment of the present invention;

FIG. 7c is a side elevation view of an end cap of the modular hydroponic growing system, according to one embodiment of the present invention;

FIG. 8a is a perspective view of a manifold of the modular hydroponic growing system, according to one embodiment of the present invention;

FIG. 8b is a perspective view of a manifold of the modular hydroponic growing system, according to one embodiment of the present invention;

FIG. 8c is a side elevation view of a manifold of the modular hydroponic growing system, according to one embodiment of the present invention;

FIG. 8d is a top plan view of a manifold of the modular hydroponic growing system, according to one embodiment of the present invention;

FIG. 9a is a perspective view of a hose connection assembly of the modular hydroponic growing system, according to one embodiment of the present invention;

FIG. 9b is a perspective view of a hose connection assembly of the modular hydroponic growing system, according to one embodiment of the present invention;

FIG. 9c is a side elevation view of a hose connection assembly of the modular hydroponic growing system, according to one embodiment of the present invention;

FIG. 9d is a top plan view of a hose connection assembly of the modular hydroponic growing system, according to one embodiment of the present invention;

FIG. 10a is a perspective view of a levered lock of the modular hydroponic growing system, according to one embodiment of the present invention;

FIG. 10b is a top plan view of a disassembled levered lock of the modular hydroponic growing system, according to one embodiment of the present invention;

FIG. 10c is a side elevation view of a disassembled levered lock of the modular hydroponic growing system, according to one embodiment of the present invention;

FIG. 10d is a perspective view of a disassembled levered lock showing how it connects to the modular hydroponic growing system, according to one embodiment of the present invention;

FIG. 11a is a perspective view of an air diffuser of the modular hydroponic growing system, according to one embodiment of the present invention;

FIG. 11b is a side elevation view of a disassembled air diffuser of the modular hydroponic growing system, according to one embodiment of the present invention;

FIG. 12a is a perspective view of a gasket of the modular hydroponic growing system, according to one embodiment of the present invention;

FIG. 12b is a perspective view of a gasket of the modular hydroponic growing system, according to one embodiment of the present invention;

FIG. 12c is a front elevation view of a gasket of the modular hydroponic growing system, according to one embodiment of the present invention;

FIG. 12d is a front elevation view of a gasket of the modular hydroponic growing system, according to one embodiment of the present invention;

FIG. 13a is a perspective view of a modular stand for the modular hydroponic growing system, according to one embodiment of the present invention;

FIG. 13b is a front elevation view of a modular stand section for the modular hydroponic growing system, according to one embodiment of the present invention;

FIG. 13c is a perspective view of a modular stand section for the modular hydroponic growing system, according to one embodiment of the present invention;

### DETAILED DESCRIPTION OF THE INVENTION

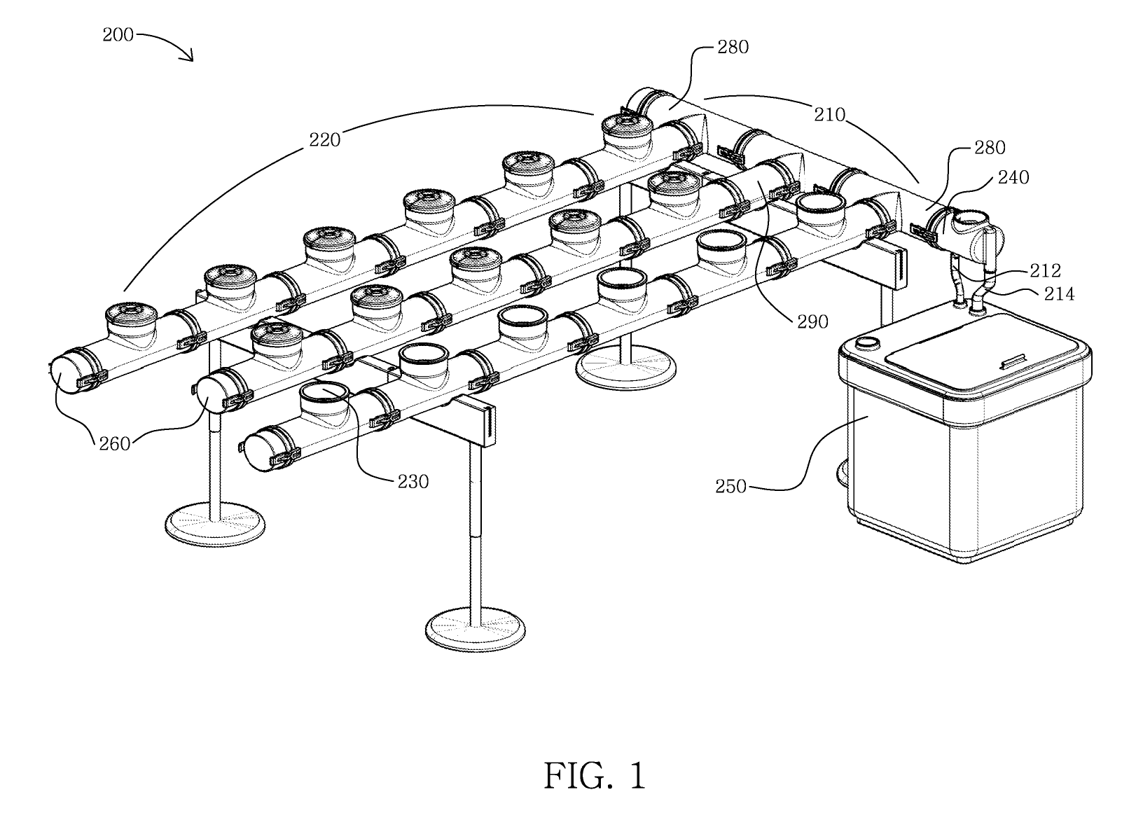

FIG. 1 shows an embodiment of the interlocking hydroponic growing system 200 of the present invention. The hydroponic growing system 200 comprises at least one branch 220 having a plurality of generally vertically arranged removable receptacles 230, for accommodating placement of the plants. In an embodiment, a trunk 210 connects with one or more of the generally perpendicularly aligned branches 220. A manifold 240, configured to fill and drain the system 200 with water and/or nutrient solution, is positioned at an end of trunk 210 and maintains fluid communication between trunk 210 and a reservoir 250 via an inlet hose 212 and an outlet hose 214. At the opposite end of the trunk 210 is an end cap 260 to close the end of the trunk 210 and prevent leakage of fluids from the system 200. The reservoir 250 holds the majority of the water or nutrient solution that is periodically introduced and removed from the system to feed and grow the plants. The system optionally comprises a pump (not shown) and a timer (not shown) within reservoir 250.

The trunk 210, which receives one or more branches 220, can be constructed using a combination of one or more T-fitting sections 280, one or more end caps 260, and optionally, one or more extension sections 290. The branches 220 can be constructed using a combination of one or more receptacle sections 270, one or more end caps 260, and optionally with one or more extension sections 290 and one or more T-fitting sections 280.

In an embodiment, the system is constructed to provide maximum growing space around each plant, so the receptacles 230 are offset diagonally from one another rather than adjacent. This can be done by placing an extension section 290 in between the first receptacle section 270 of a branch 220 and T-fitting section 280 of trunk 210 for every other branch 220. This way the parts are designed to maintain specific spacing to maximize growing area.

In an embodiment, spacing can be adjusted to individual needs by utilizing extension parts. For example T-fitting sections 280 can be added or removed from the trunk 210 to add or remove, respectively, branches 220. As another example, receptacle sections 270 can be added or removed from the branches 220 to lengthen or shorten, respectively, the branches 220. Similarly, extension sections 290 can be added or removed from the trunk 210 and/or branches 220 to vary spacing among plants as needed.

For support, the assembly can rest on, be attached to, or be suspended from a support structure such as a platform, table or stand, beam or ceiling.

In a preferred embodiment, the trunk 210 and branches 220 are co-planar and situated above the reservoir holding the water or solution, such that when the liquid fills the assembly the fluid level is generally the same throughout the tubing.

At regular intervals, the water or nutrient solution is pumped out of reservoir 250 via a pump (not shown) disposed inside reservoir 250, and through the outlet hose 214 into trunk 210. The water or solution then flows from the trunk 210 into each branch 220, thereby providing each receptacle 230 with water and/or nutrient solution to moisten and/or nourish the plant roots (not shown). Having been circulated, the water or nutrient solution drains back down into reservoir 250 via inlet hose 212.

In an embodiment, the user can program the pump (not shown) to turn on or off automatically at desired intervals via a timer (not shown).

In another embodiment, the user can turn the pump (not shown) on or off manually by a switch (not shown).

In an embodiment, the branches 220 and the trunk 210 are sloped, such that when the pump (not shown) is turned off, any water within the branches 220 and/or trunk 210 drains, via gravity, to the reservoir 250. This prevents any excess water from pooling within the branches 220 and/or trunk 210 that could potentially result in, among other things, damage to plant roots and mold growth.

In another embodiment, the system forms a closed loop in order to continuously circulate the water or solution for a fixed period of time through the tubes. This provides the benefit of allowing each plant to soak in adequate amounts of water, air, and nutrients. The result of this feature is that higher yields of high-quality produce are obtained over an extended period of cropping.

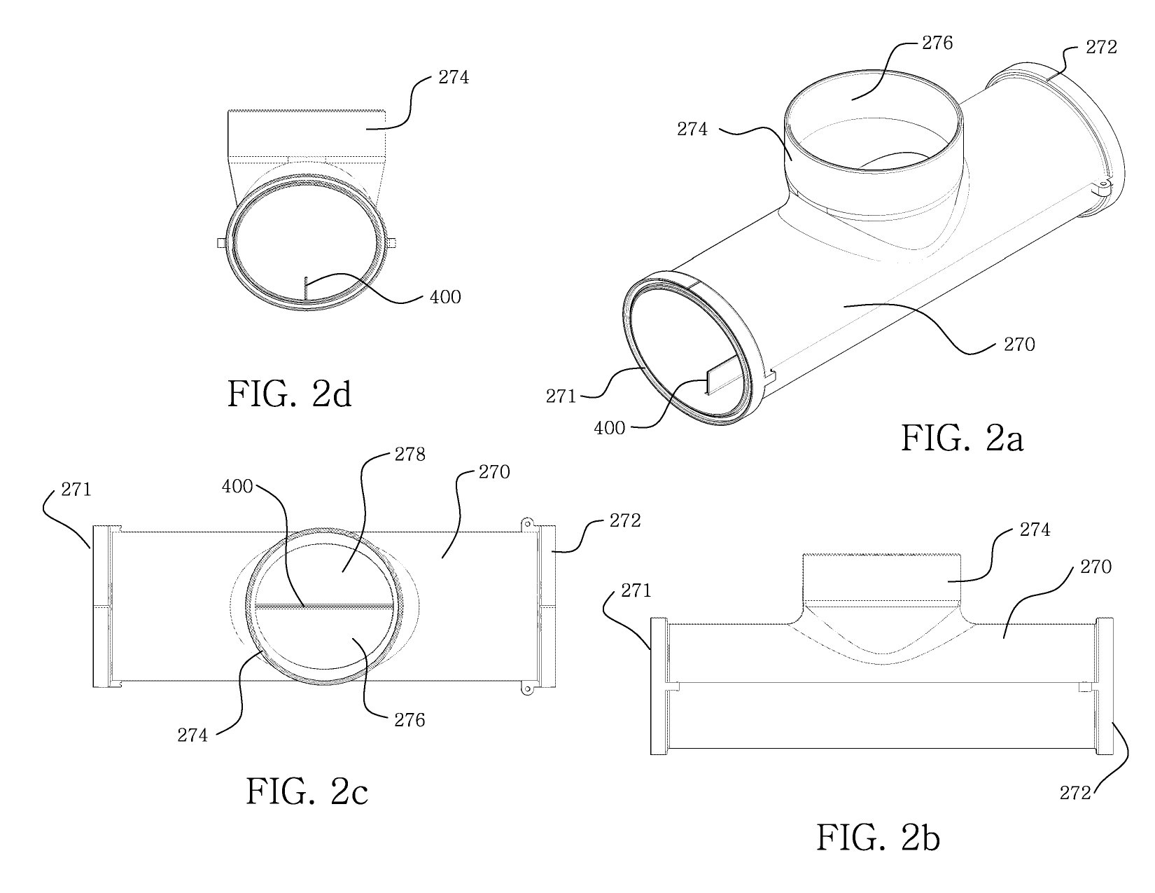

Referring now to FIGS. 2a through 2d, receptacle section 270 is a T-pipe that has opposite ends 271, 272, and a perpendicularly aligned portion 274. The perpendicularly aligned portion 274 of receptacle section 270 is defined by an aperture 276 that is capable of receiving receptacle 230 for holding a plant. The perpendicularly aligned portion 274 tapers to the inside diameter of the T-pipe forming a chamber 278, allowing the receptacles 230 to rest snugly in the chamber 278 of receptacle section 270.

In a preferred embodiment, each of the receptacle sections 270 described, depicted and/or embodied herein has a fin 400 that is upwardly disposed from the interior bottom surface of the receptacle section 270. The fin 400 extends below each receptacle 230, and is configured to support the roots and prevent them from settling to the bottom surface of the section 270, thus allowing the system to properly and efficiently drain while preventing the roots from potentially being harmed from prolonged exposure to moisture.

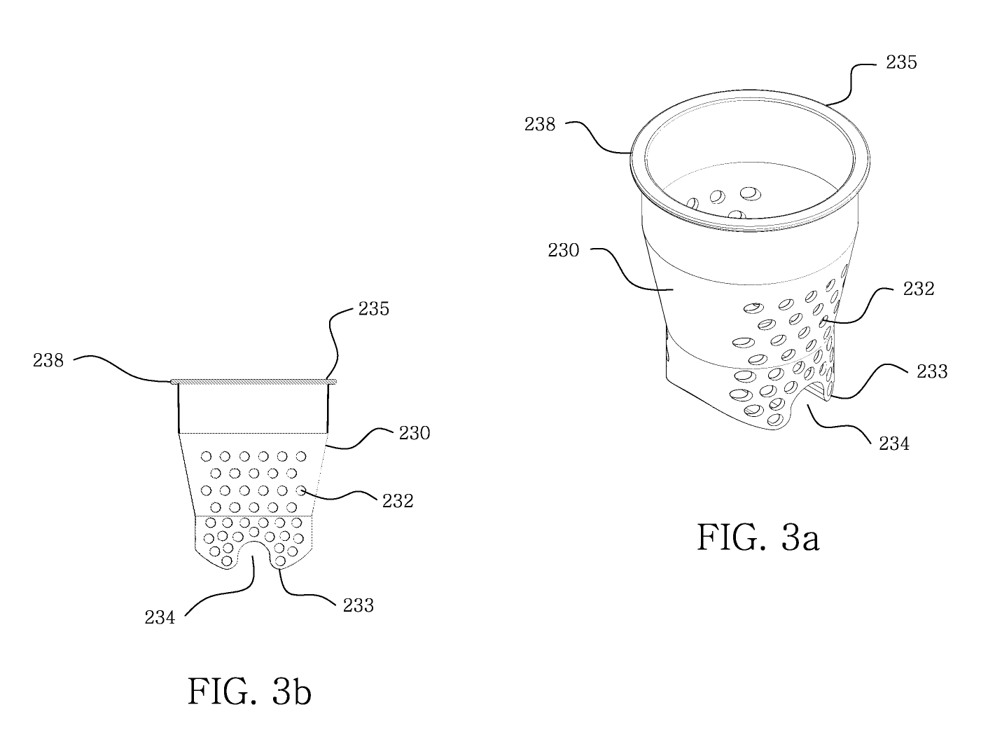

Referring to FIGS. 3a and FIG. 3b, in a preferred embodiment, receptacle 230 is designed to hold plants in a pot tapering from its top 235 to its bottom 233. In one embodiment, the receptacle is in the form of a truncated cone. The sides of receptacle 230 have a plurality of holes 232 to facilitate the absorption of water, air and nutrients by the roots (not shown). The foot 233 is shaped to fit against the rounded bottom of the receptacle section 270, and has an open-ended channel 234 running through the bottom of receptacle 230 to prevent blockage of receptacle section 270, thus allowing a continuous flow of water or solution throughout receptacle section 270 and branches 220. The top of receptacle 230 has a rim 238 slightly larger in diameter than the perpendicularly aligned portion 274 of the receptacle section 270 that allows the pot to rest vertically in the chamber 278 (see FIG. 3b) of receptacle section 270, without falling in. Receptacle 230 is designed to fit snugly inside receptacle section 270 to support the weight of heavy crops.

The receptacles 230 allow the plants to soak in nutrients so that the plant roots are exposed to adequate supplies of water, oxygen, and nutrients. In one embodiment, the receptacles could be made of dense or flexible materials such as plastic or aluminum, as long they contain a plurality of holes to facilitate exposure to the water, oxygen, and nutrients.

In another embodiment, the receptacles 230 are made of recycled or porous materials such as a sponge or permeable plastic that would allow the water, nutrient solution and air to penetrate the receptacle 230 and come in contact with the plant roots.

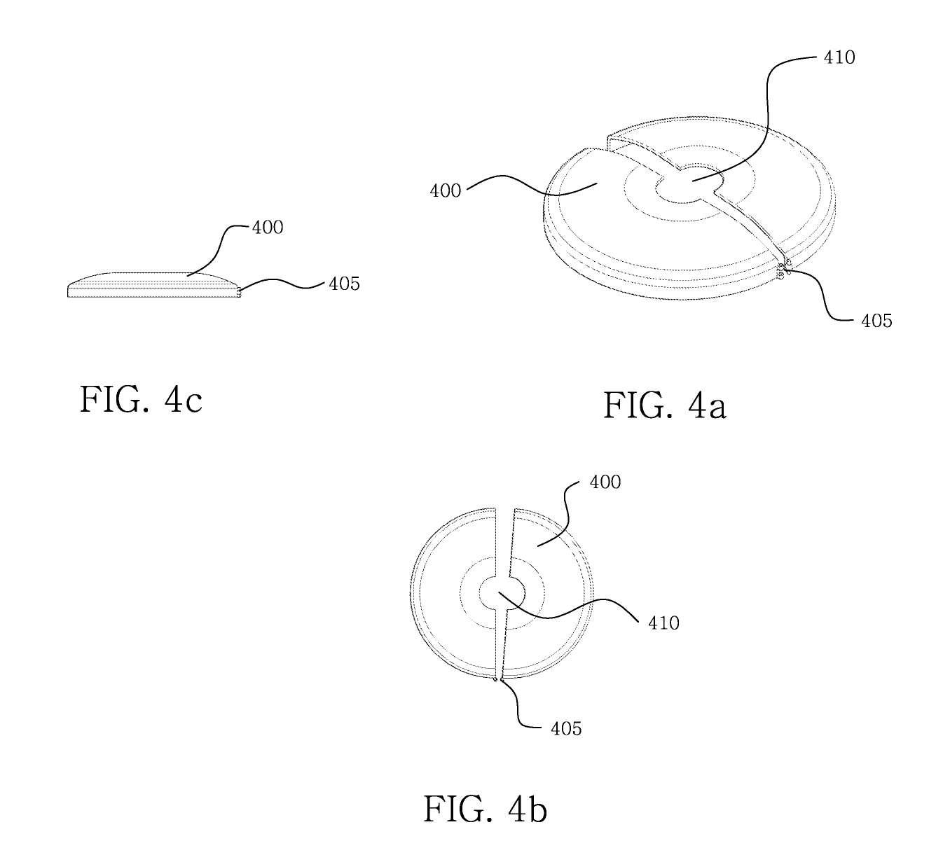

With reference to FIGS. 4a through 4c, in a preferred embodiment, a cover 400 is releasably connected to the top of the receptacles 230. The cover 400 has two halves that are connected to one another by a hinge 405. Additionally, an aperture 410 extends through the cover 400, such that when the cover 400 is hinged open, a plant body (not shown) can be positioned within the aperture 410. When the plant is properly positioned, the cover 400 is closed, thus blocking light from reaching the growing medium and preventing the growth of mold, etc. that can compete for the plant's nutrient source.

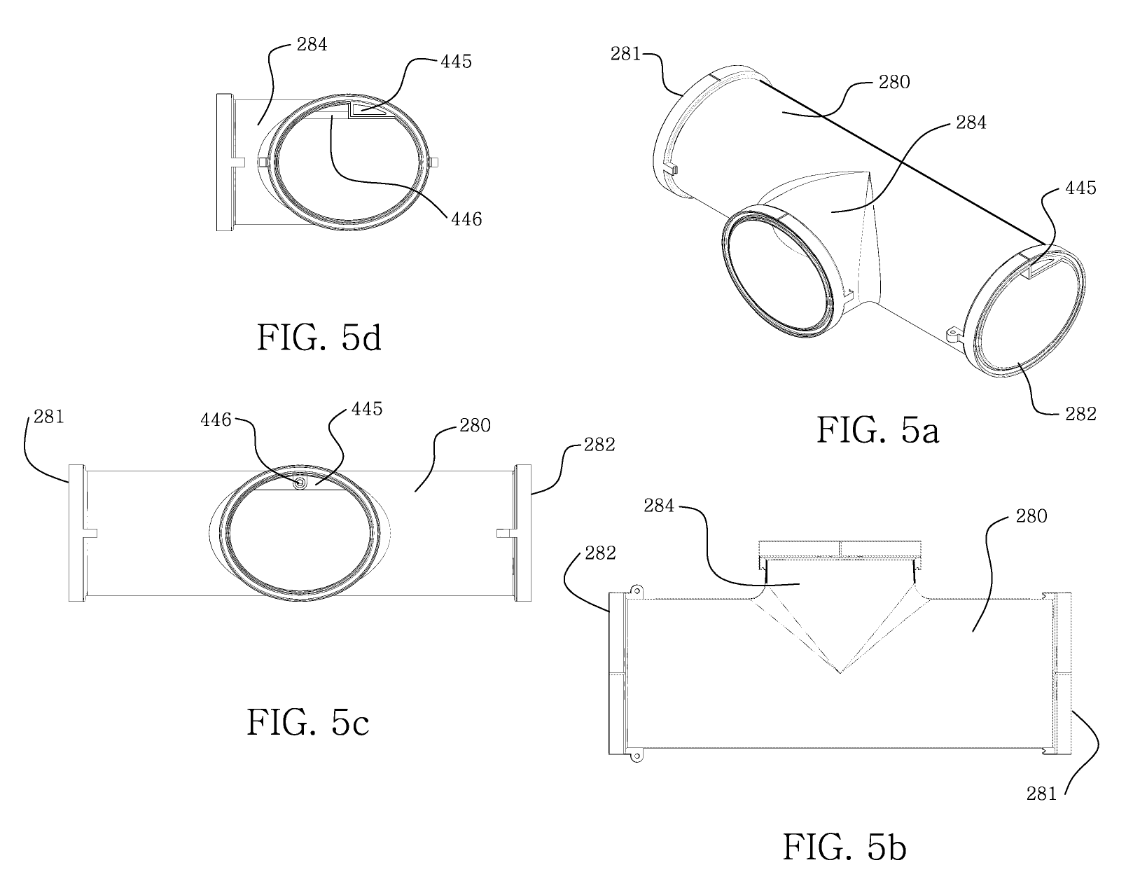

Referring to FIGS. 5a through 5d, T-fitting section 280, like receptacle section 270, is a T-pipe that has opposite ends 281, 282 and a perpendicularly aligned portion 284. Opposite ends, 281, 282 are configured to matingly engage with the various adjoining components that comprise the trunk 210. The perpendicularly aligned portion 284 of T-fitting section 280 extends outward from generally the center of T-fitting section 280. The perpendicularly aligned portion 284 is configured to matingly engage with an adjoining section of a branch 220.

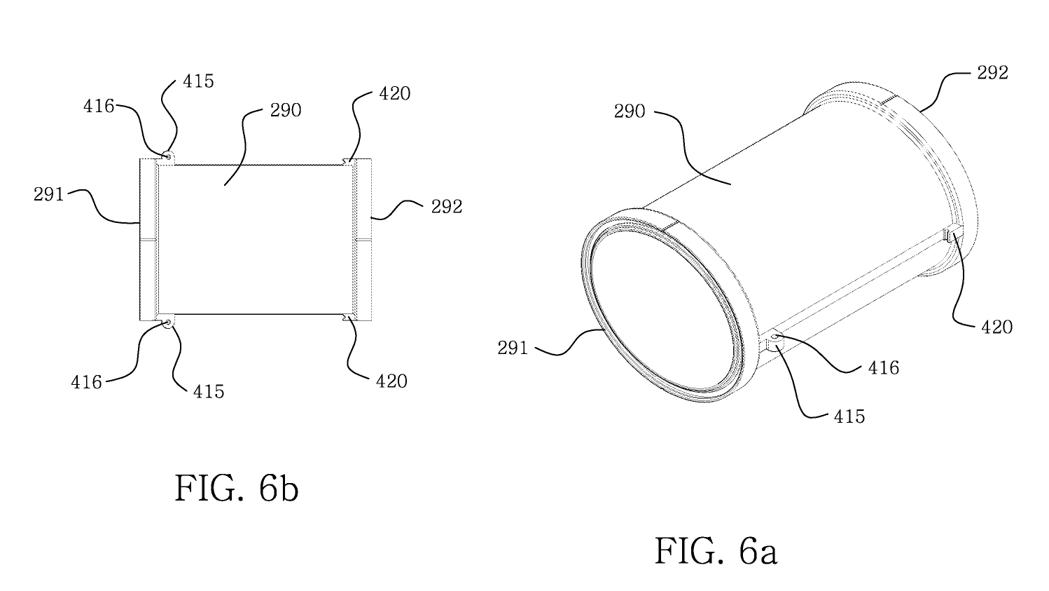

With reference to FIG. 6a and FIG. 6b, extension section 290 is a straight hollow tube having two opposite ends 291, 292 configured to matingly engage with, and connect, the various sections and/or components that comprise the trunk 210 and/or the branches 220.

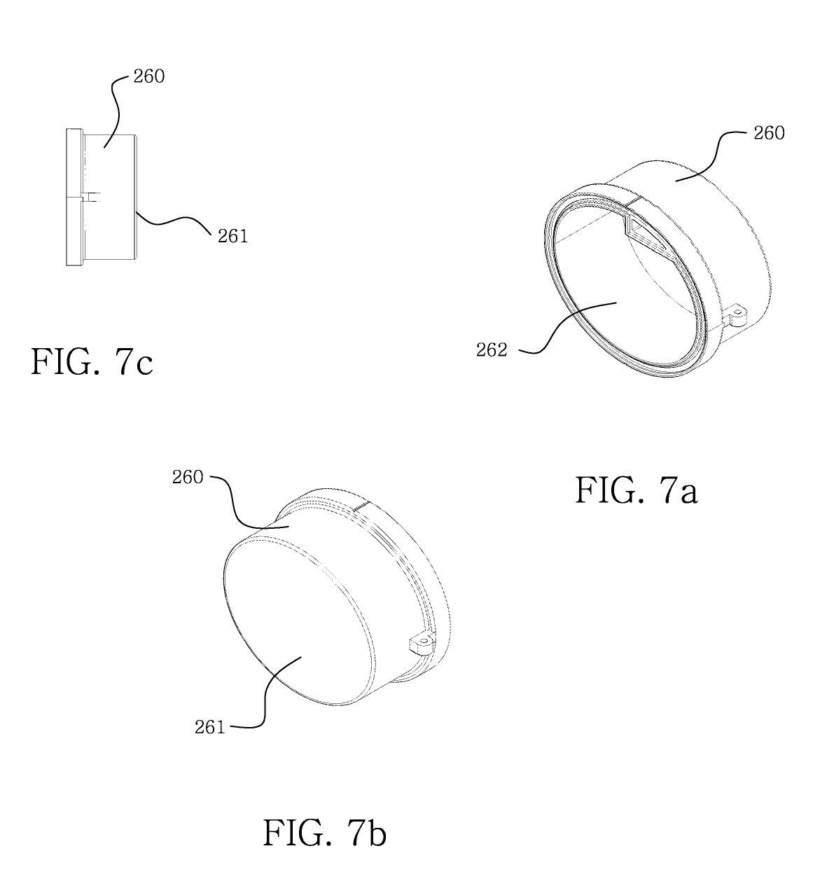

Referring now to FIGS. 7a through 7c, end cap 260 is an annular fitting with an enclosed end 261, defining a cavity 262 at the opposite end. End cap 260 serves to cover or close the ends of trunk 210 and the one or more perpendicularly aligned branches 220, preventing the water or solution from escaping the system 200. Additionally, the end caps 260 can be removed to allow a user to easily add or remove sections to alter the system's configuration. Once the configuration has been altered, the end caps 260 are re-attached.

Trunk 210 and branches 220 can be shortened by disconnecting and removing the T-fitting sections 280, extension sections 290, or receptacle sections 270 and covering the ends with end caps 260. Similarly, trunk 210 and perpendicularly aligned branches 220 can be extended by removing the end caps 260, adding more T-fitting sections 280, extension sections 290, or receptacle sections 270, and placing end caps 260 on the end(s) of the extension(s).

In one embodiment, the system is constructed to provide maximum growing space around each plant, so the receptacles 230 are offset diagonally from one another rather than adjacent. This can be done by placing an extension section 290 in between the first receptacle section 270 of a branch 220 and T-fitting section 280 of trunk 210 for every other branch 220. This way the parts are designed to maintain specific spacing to maximize growing area.

In an embodiment, spacing can be adjusted to individual needs by utilizing the extension parts.

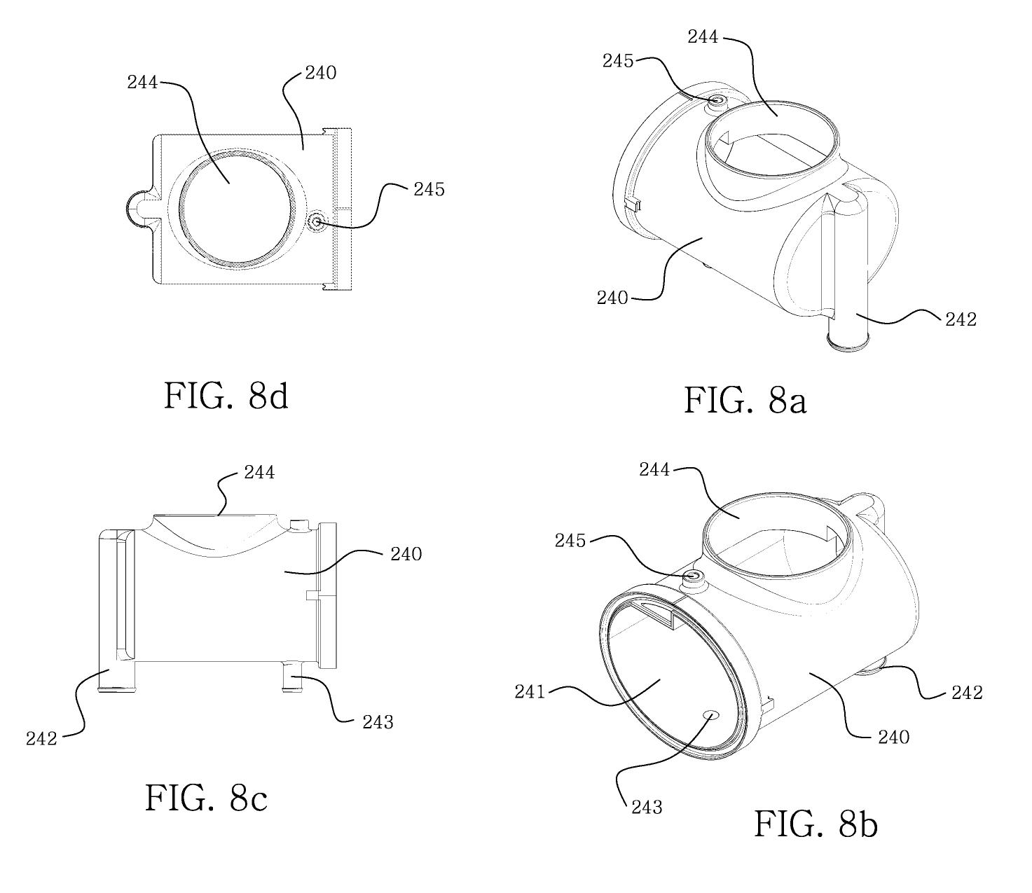

With reference to FIGS. 8a through 8d, an embodiment of the manifold 240 of the hydroponic growing assembly 200 is shown. Manifold 240 is a hollow structure with an open end 241 and an enclosed opposing end having an outlet hose extension 242 that extends downwardly from the bottom of manifold 240. Manifold 240 also has a cylindrical hollow inlet hose extension 243 that extends downwardly from the bottom of the manifold 240 near the center of manifold 240. Air port 245, configured to receive an air hose (not shown), for example using a friction fit, is located on a top surface of the manifold 240 adjacent to the open end 241. In a preferred embodiment, air is introduced into the system 200 for aeration of the plants (not shown) through the air port 245 where it enters, and travels through, the air line 445 (see FIGS. 5a, 5c, 5d, 7a, 8a, 8b, 9a, and 9b). In an embodiment, manifold 240 has an opening 244 at the top for access to the interior of the manifold 240 in order to clean and perform maintenance, clear debris, or observe water flow.

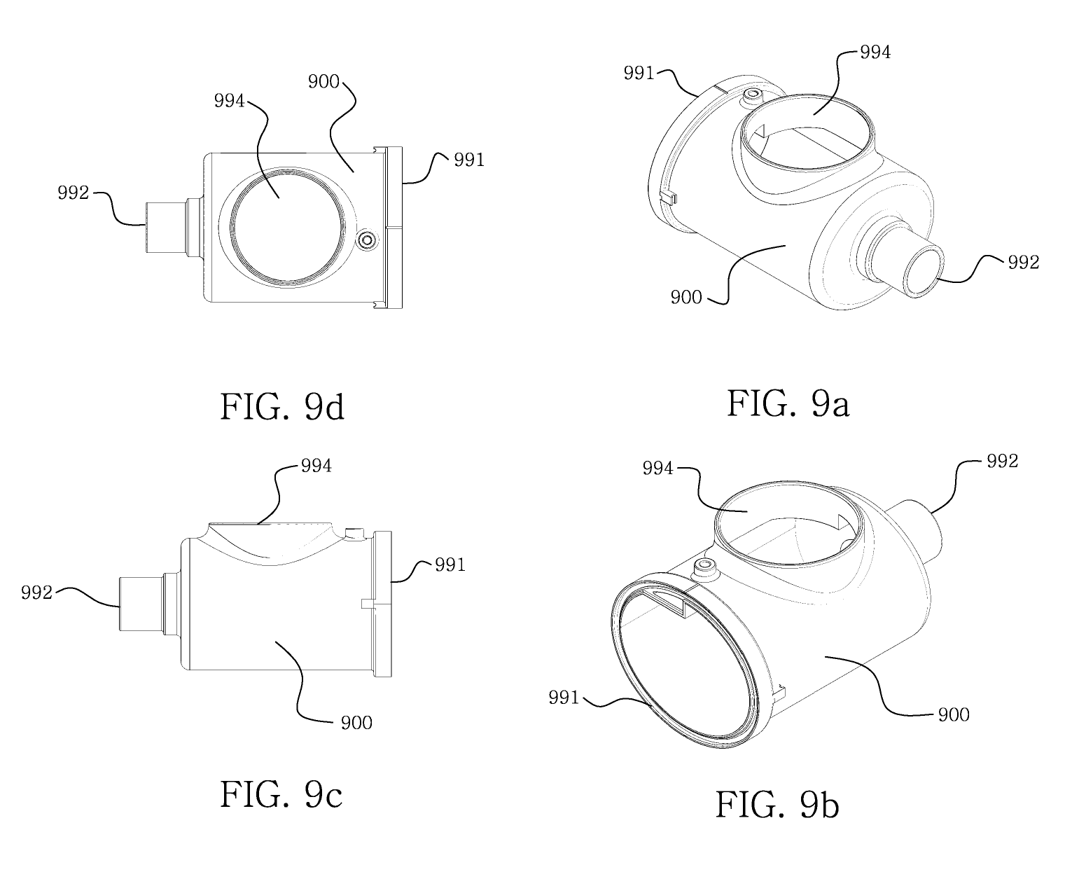

In an alternative embodiment as shown in FIGS. 9a through 9d, a hose connection assembly 900 can be used in place of manifold system and assembly 240. Hose connection assembly 900 has two opposing ends 991 and 992, wherein one end 991 is configured to sealingly engage with the trunk and the opposing end 992 is configured to engage with a standard hose. In an embodiment, hose connection assembly 900 has an opening 994 at the top for access to the interior of the hose connection assembly 900 in order to clean and perform maintenance, clear debris, or observe water flow.

In an alternative embodiment, system 200 uses hose connection assembly 900, wherein a pump (not shown) rests in a reservoir, such as a pond or other body of water. One end of a hose is connected to the pump (not shown), and the other end of the hose is connected to the hose connection assembly 900. The pump pumps the water or solution from the reservoir through the hose and into the trunk via hose connection assembly 900. The water or solution then flows into the branches and empties back into the reservoir where it is re-circulated through the system. The trunk and/or branches have a downward slope so that gravity directs the water or solution into the reservoir after use. The hose connection assembly 900 allows the system to be a closed loop system, as mentioned above, which re-circulates the nutrient-dense water or solution.

In a preferred embodiment, receptacle section 270, manifold 240, T-fitting section 280, extension section 290, end cap 260, and hose connection assembly 900 are made of lightweight, but resilient, rigid and watertight materials such as plastic, aluminum, or structural composite to add strength to the system and prevent leakage.

In a preferred embodiment, reservoir 250 is built of plastic, but other materials such as concrete, glass, metal, vegetable solids, and wood can be used.

In a preferred embodiment, each of the modular, interconnected sections described, depicted and/or embodied herein has an oval-shaped circumference. This configuration provides additional space on the sides of the receptacles 230, in addition to the open space through the channel at the bottom of the receptacles 230, providing increased water flow. Additionally, the oval shape allows more space for the roots to grow horizontally, thus decreasing the likelihood of the roots clogging the system.

Referring again to FIGS. 6a and 6b (as an example), in a preferred embodiment, located on an exterior surface adjacent to one opening of each of the modular, interconnected sections described, depicted and/or embodied herein is a pair of connection points 415. Each connection point 415 has an aperture 416 that extends down through the connection point 415. Located on an exterior surface adjacent to the opening at the opposite end of each section is a pair of protrusions 420 that are generally horizontally aligned with the connection points 415. The connection points 415, and the protrusions 420 alike, are located directly across each section's diameter from one another. Components, such as an end cap 260 or a manifold 240, having only one open end, have either a pair of connection points 415 or a pair of protrusions 420 adjacent to their opening configured as detailed above. Similarly, each T-fitting sections 280 has an additional pair of connection points 415 or protrusions 420 at the opening of the perpendicularly aligned portion 284, wherein the connection points 415 or protrusions 420 are configured as detailed above.

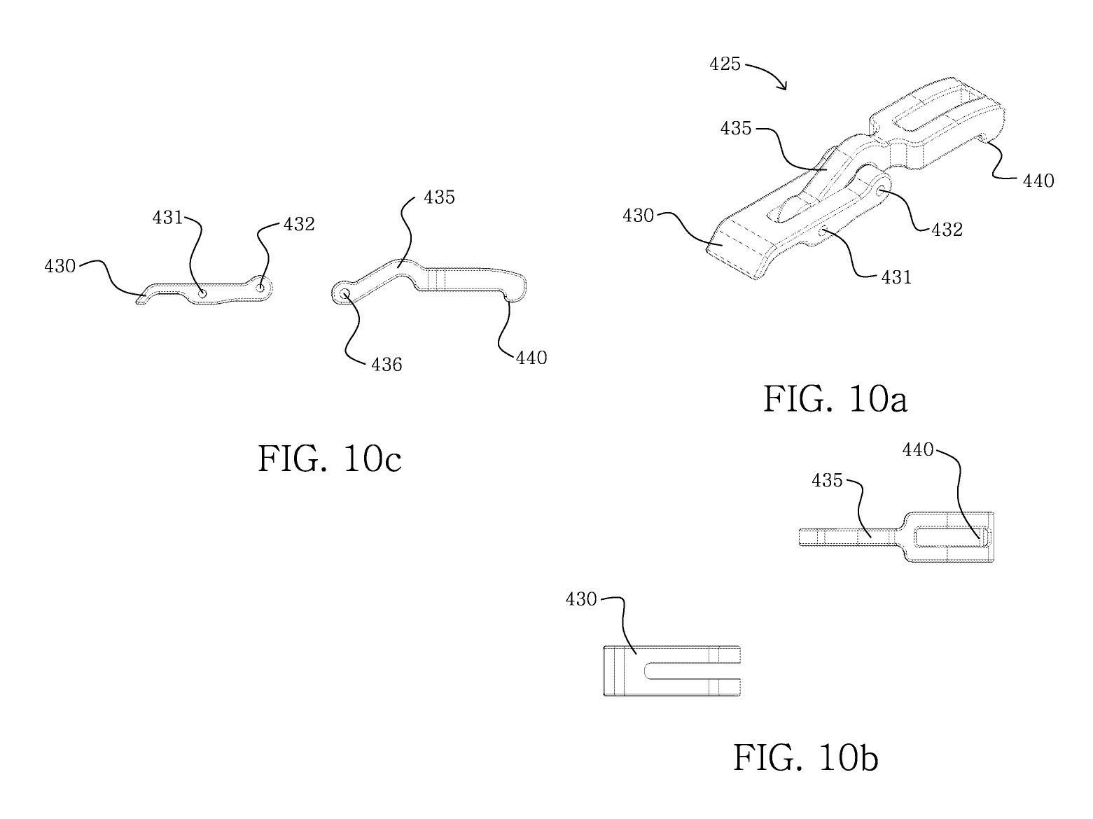

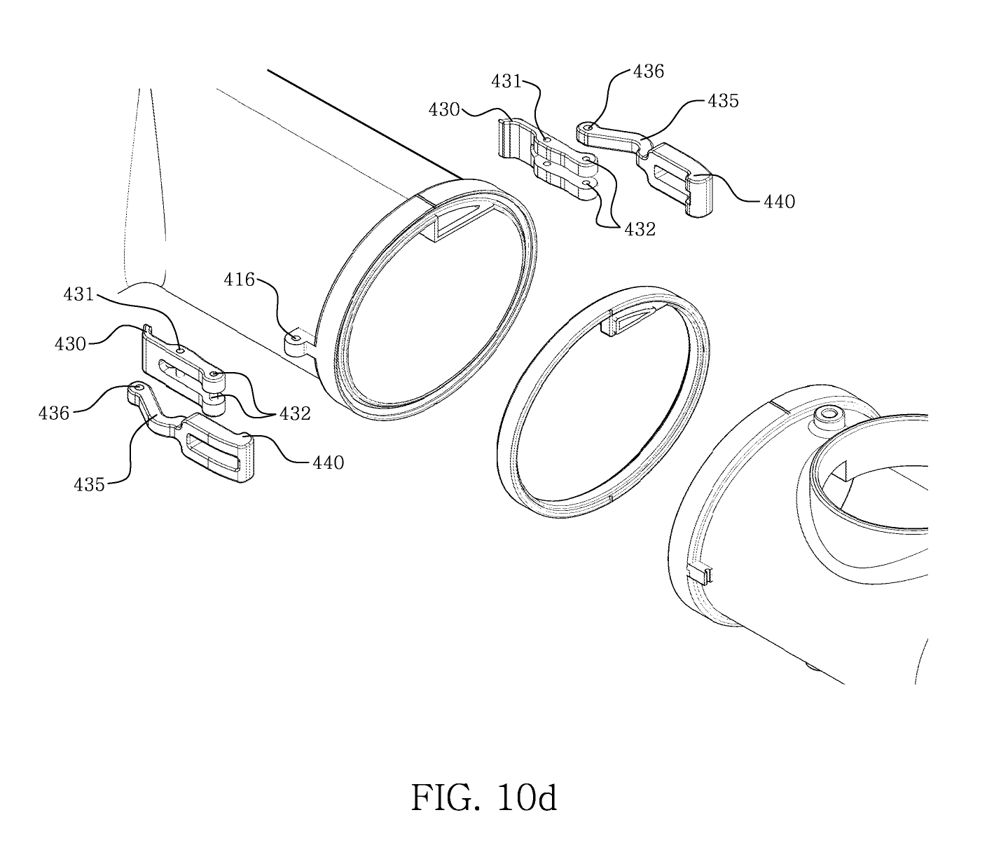

With reference to FIGS. 10a through 10d, a locking lever 425 has a handle 430 and a catch arm 435 that has an inwardly extending catch 440 for releasably engaging with a protrusion 420 of an adjoining section. The handle 430 is a generally U-shaped handle having two pairs of axially aligned apertures 431, 432. The catch arm is generally Y-shaped, wherein the top of the “Y” is bridged together, having an aperture 436 extending through a lower portion of the “Y”.

The handle 430 is hingedly connected to each of the system's sections by inserting a pin (not shown) through apertures 416, 432 in the handle 430 and the connection point 415, respectively, that correspond, and axially align, with one another. Similarly, the handle 430 and the catch arm 435 are hingedly connected to one another by inserting a pin (not shown) through apertures 431, 436 in the handle 430 and the catch arm 435, respectively, that correspond, and axially align, with one another. When the catch 440 engages the protrusion 420 of an adjoining section, the handle 430 is hinged away from the catch 440, causing the adjoining sections to be pulled together as the handle 430 moves toward a locked position in which the handle 430 is generally flush with the section to which it is attached. When the handle 430 reaches the locked position, the adjoining sections abut one another and are sealingly engaged with one another to prevent leaks.

Referring again to FIGS. 5a, 5c, 5d, 7a, 8a, 8b, 9a, and 9b, in a preferred embodiment, the manifold 240 or hose connection assembly 900, and each modular, interconnected section of the trunk 210 described, depicted and/or embodied herein (inclusive of T-fitting sections 280, extension sections 290, and end caps 260) has an air line 445 integrated into their interior wall that extends the length of the section, and in the case of a T-fitting section 280, an extension 446 releasably connected to the air line 445 extends outwardly from the air line 445 into the perpendicularly aligned portion 284. The air lines 445 integrated within the T-fitting sections 280 and extension sections 290, as well as the air line extension 446, are hollow channels having open ends; whereas, the air lines 445 integrated within the manifold 240, hose connection assembly 900, and end caps 260 are hollow channels having an open end that corresponds with the open end of the respective section or component, and a closed end, wherein the closed end is configured to prevent air from unnecessarily escaping from the air line.

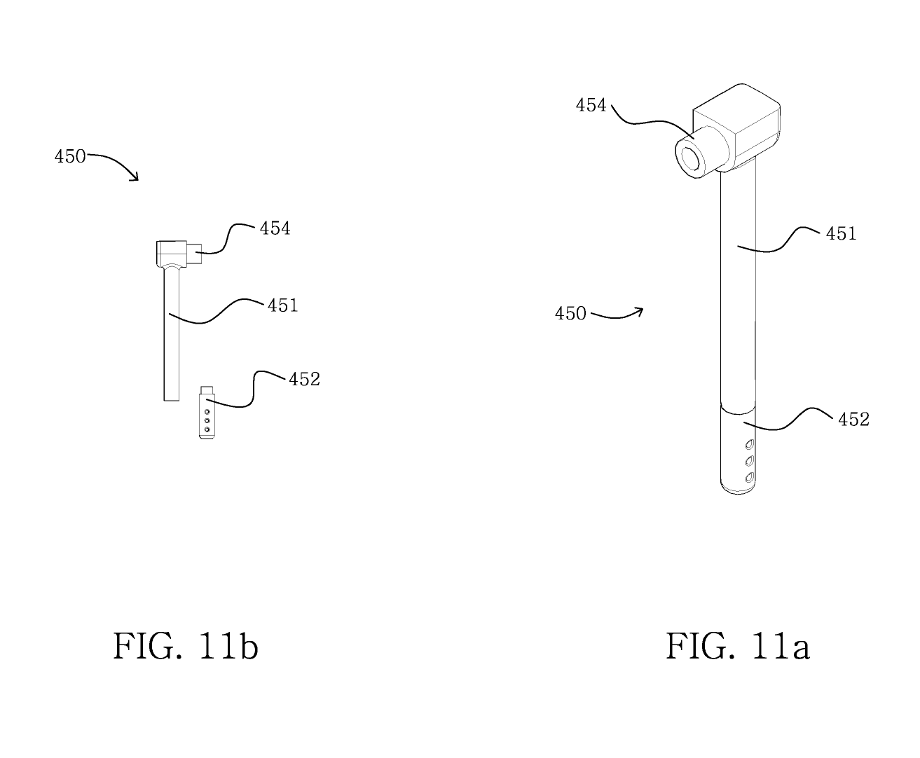

With reference to FIGS. 11a and 11b, in a preferred embodiment an air diffuser 450 is connected to the air line extension 446 to aerate the system. The diffuser 450 is a two-part air diffuser 450 having a generally L-shaped hollow upper portion 451 removably connected, for example by a male/female friction fit, at its lower end to a hollow lower portion 452. A nipple 454 extends outwardly from the upper portion's upper end, wherein the nipple 454 releasingly engages with the air line extension 446, for example by a male/female friction fit, within the perpendicularly aligned portion 284 of the T-fitting section 280 to connect the diffuser 450 to the air line extension 446. The lower portion 452 has a plurality of holes 453 extending from its interior to its exterior, wherein the lower portion 452 is configured to extend into the water to aerate the system.

In another embodiment, air stones (not shown) are removably connected to the air line extension 446 in place of the diffuser 450, allowing the user to alter aeration of the system to suit the user's needs.

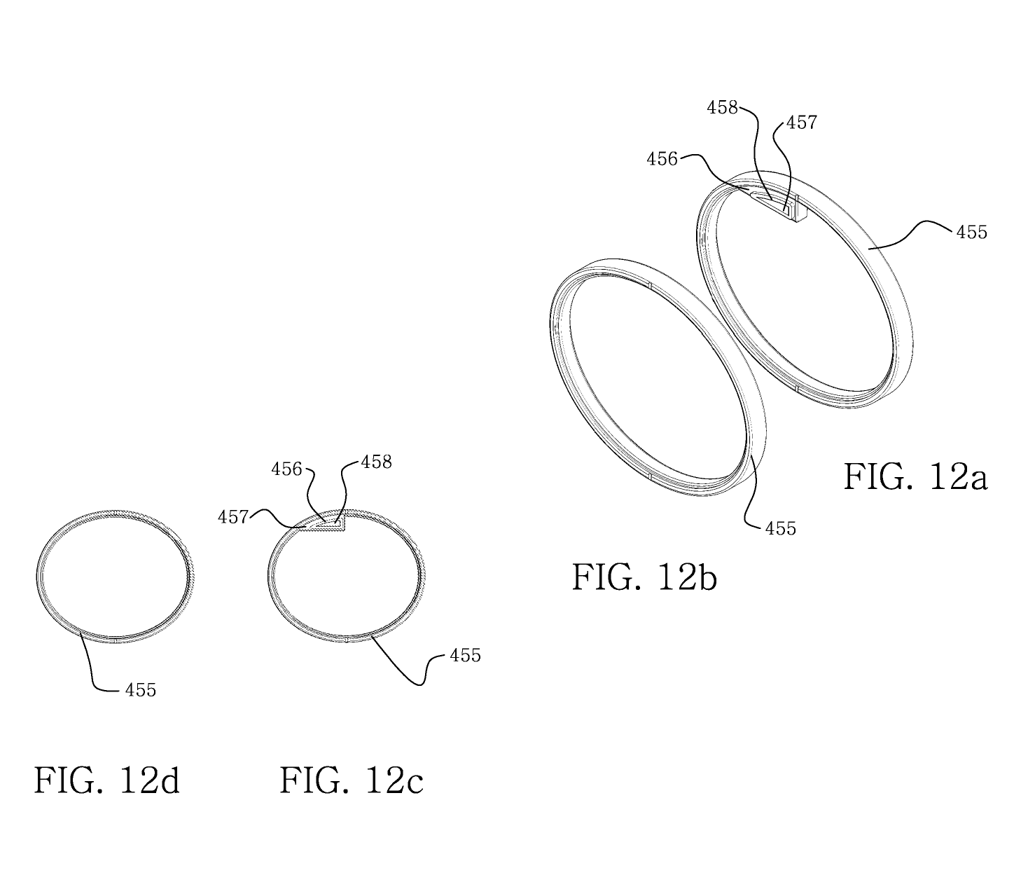

With reference to FIGS. 12a through 12d, in a preferred embodiment, a gasket 455 is inserted between each pairing of modular, interconnected sections described, depicted and/or embodied herein. The gasket 455 is configured to align with, and seal adjoining section openings to one another to prevent leaks. In an embodiment, the gasket 455 has an inwardly extending protrusion 456 that is configured to align with, and seal, the air lines 445 of the adjoining sections to one another to prevent unwanted loss of air pressure at the various junctures within the system. An aperture 457 extends through the protrusion 456 and has an outer lip 458 that matingly engages with the air line 445. The gasket 455 is constructed of silicone, rubber, or any other material that would be known and appreciated by one reasonably skilled in the art for preventing leaks.

In an alternative embodiment, the openings of each modular section described herein are either a male or a female connector that allows the sections to matingly engage with one another by inserting a male connector of one section or component into a corresponding female connector of an adjoining section or component. The female connector has an inner diameter that is slightly greater than or equal to the outer diameter of the male connector forming an air- and water-tight connection when the male connector frictionally engages with a corresponding female connector. A matingly compatible end cap 260 is releasably affixed, by a friction fit, to the end of each receptacle section 270 furthest from the trunk 210 to prevent leakage of fluid from the system. Similarly, the end of the trunk 210 opposite the end connected to the reservoir 250, has an end cap 260 matingly engaged thereto to prevent leakage of fluid from the system.

In an embodiment, an adhesive can be added between any adjoined pair of connectors and/or end caps to bind the respective parts together, similar to ABS or PVC piping systems.

The interconnectivity among the various system components described, depicted, and/or embodied herein creates a system that is capable of assembly, disassembly, repair, and/or maintenance without using tools, thereby minimizing time and effort of assembly, disassembly, repair, and/or maintenance.

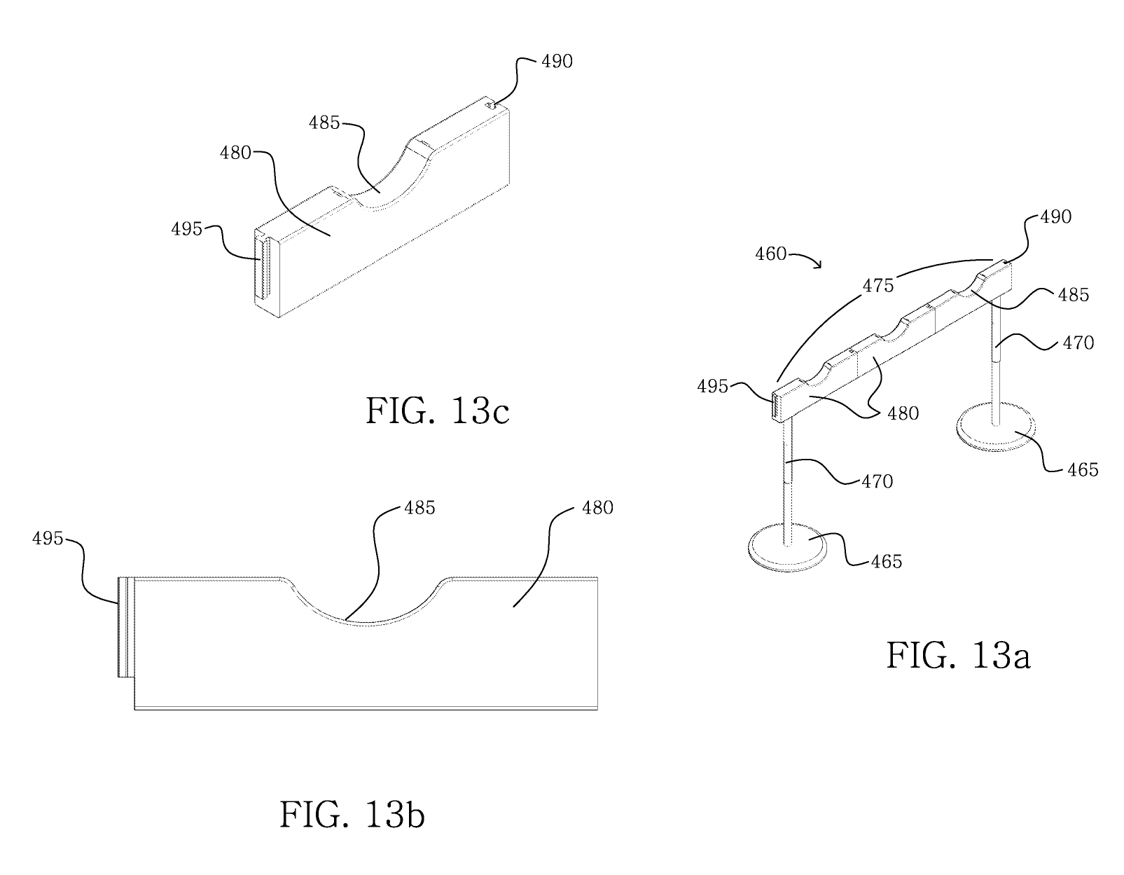

Referring now to FIGS. 13a through 13c, in a preferred embodiment, modular stands 460 are used to support the system. Each stand 460 has at least two bases 465, from which legs 470 extend upwardly therefrom. The height of the legs 470 can be adjusted to allow a user to adjust the height and/or slope of the system. Connected to the top of each leg 470 is a multi-section interconnected lateral support beam 475, each support section 480 having a recessed groove 485 that accepts and matingly engages a bottom portion of a branch 220 to secure the branch 220 in place and prevent lateral movement. Each of the beam's support sections 480 have a vertical channel 490 at one end and a mating protrusion 495 at the opposite end, wherein the protrusion 495 and the channel 490 are generally the same height, which height is less than the height of the support section 480. The protrusion 495 engages the channel 490 by sliding into the channel 490 from the channel's top, allowing the support sections 480 to interlock end-to-end with one another to form the beam 475.

In a preferred embodiment, light is prevented from passing into the system to prevent algae growth in the nutrient solution. The nutrient solution is changed either on a schedule, such as once per week, or when the nutrient concentration drops below a certain level as determined, for example, by an electrical conductivity meter. Whenever the solution is depleted below a certain level, either water or fresh nutrient solution is added and a Mariotte's bottle, or a float valve, can be used to automatically maintain the solution level.

The parts may be made available individually or the assembly may be sold in a variation of kits, whereby each kit will contain all the parts needed to build the assembly, and each variation can have a different number of parts, depending on the needs of, and space available to, the user. This allows the user to design the system in a number of different and imaginative ways for a particular space. The present invention provides an easy-to-assemble kit for novice and/or skilled users that contains all the uniquely manufactured parts made specifically to for this hydroponic system. As an example, the fill and drain section (i.e., the manifold) of the present invention is uniquely manufactured as a single-piece section.

In preferred embodiment, the kit would be available in various sizes, for example 50 gallon, 25 gallon or 7 gallon. By using less water and smaller basins, the system of the present invention allows the growing plane to be lower, allowing for increased vertical growing area. One reasonably skilled in the art would appreciate and understand that, being a modular system that can be constructed using various diameter and/or length pipe, the size and configuration of the present system is only constrained by space available to the user. Therefore, the present system can be as small or as large as a user desires, without deviating from the scope of the invention.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the specification as a whole.

I claim:

1. A modular hydroponic system, comprising:
a. a reservoir;
b. a manifold in communication with the reservoir, wherein the manifold is configured to receive a liquid from the reservoir and to allow the liquid to drain back into the reservoir;
c. a pump in communication with the reservoir, the pump being configured to pump the liquid from the reservoir into the manifold;
d. a trunk having a first end and a second end, wherein the first end is releasably connected to the manifold, wherein the trunk comprises:
i. one or more T-fitting sections; and
ii. an end cap releasably connected at the second end of the trunk, wherein the end cap is configured to close the second end of the trunk;
e. an air line integrated into an interior wall of the manifold and the trunk, the air line extending from the manifold through the trunk; and
f. one or more branches having a first end and a second end, wherein the first end of each of the one or more branches is releasably connected to one of the one or more T-fitting sections of the trunk, wherein the one or more branches comprises:
i. one or more receptacle sections; and
ii. one or more end caps releasably connected to the second end of the one or more branches, wherein the one or more end caps are configured to close the second end of each branch.

2. The modular hydroponic system of claim 1, wherein the trunk further comprises one or more trunk extension sections, configured to extend the trunk.

3. The modular hydroponic system of claim 1, wherein the one or more branches further comprise one or more branch extension sections, configured to extend the one or more branches.

4. The modular hydroponic system of claim 1, wherein the air line further comprises:
a. an extension releasably connected to the air line, wherein the extension extends toward the one or more branches; and
b. an aeration device selected from the group consisting of an air diffuser and an air stone, wherein the aeration device is releasably connected to the air line extension.

5. The modular hydroponic system of claim 1, further comprising one or more receptacles removably inserted into the one or more receptacle sections.

6. The modular hydroponic system of claim 1, wherein the one or more receptacle sections comprises a fin upwardly disposed from an interior bottom surface of the one ore more receptacle sections.

7. The modular hydroponic system of claim 3, wherein the manifold, the trunk, the one or more branches, and the one or more branch extensions are tubular components connected by a plurality of fastener systems, each fastener system comprising:
a. a gasket positioned between an abutment of the tubular components; and
b. two or more locking levers, each on opposite sides of each of the tubular components, each locking lever comprising a handle and a latch arm, wherein the handle is configured to engage with the latch arm to pull it closed as the handle is pushed against the tube,
wherein the first end of the trunk and the first end of the one or more branches have two or more connection points adjacent thereto, each connection point having an aperture for accommodating the locking lever handle, and wherein the second end of the trunk and the second end of the one or more branches have two or more protrusions adjacent thereto configured to be releasably engaged by a latch arm of the locking lever, wherein a catch at an end of the latch arms of the two or more locking levers is configured to releasably engage with the two or more protrusions, wherein when joined by the plurality of locking levers, the abutting tubes are sealingly engaged.

8. The modular hydroponic system of claim 1, wherein a cross section of the manifold, the trunk, and the one or more branches is oval.

9. The modular hydroponic system of claim 1, wherein the trunk and the one or more branches are downwardly sloped toward the reservoir.

10. The modular hydroponic system of claim 1, further comprising a modular stand, comprising:
a. at least two bases;
b. at least two legs extending upwardly from the at least two bases, wherein the at least two legs are height adjustable; and
c. a lateral support beam releasably connected to a top of the at least two legs, the lateral support beam comprising one ore more support sections, wherein the one or more support sections have a recessed groove on a top surface, a vertical channel on a first end, and a protrusion on a second end.

11. A modular hydroponic system, comprising:
a. a reservoir;
b. a manifold in communication with the reservoir, wherein the manifold is configured to receive a liquid from the reservoir and to allow the liquid to drain back into the reservoir;
c. a pump in communication with the reservoir, the pump being configured to pump the liquid from the reservoir into the manifold;
d. a trunk having a first end and a second end, wherein the first end is releasably connected to the manifold, wherein the trunk comprises:
i. one or more T-fitting sections; and
ii. an end cap releasably connected at the second end of the trunk, wherein the end cap is configured to close the second end of the trunk;
e. one or more branches having a first end and a second end, wherein the first end of each of the one or more branches is releasably connected to one of the one or more T-fitting sections of the trunk, wherein the one or more branches comprises:
i. one or more receptacle sections; and
ii. one or more end caps releasably connected to the second end of the one or more branches, wherein the one or more end caps are configured to close the second end of each branch.

12. The modular hydroponic system of claim 11, further comprising an air line extending from the manifold through the trunk, wherein the air line is integrated into an interior wall of the manifold and the trunk.

13. The modular hydroponic system of claim 11, further comprising one or more receptacles removably inserted into the one or more receptacle sections.

14. The modular hydroponic system of claim 11, wherein the trunk further comprises one or more trunk extension sections having two open ends for extending the trunk.

15. The modular hydroponic system of claim 11, wherein the one or more branches further comprise one or more branch extension sections having two open ends for extending the one or more branches.

16. The modular hydroponic system of claim 11, wherein the air line further comprises:
a. an extension releasably connected to the air line, wherein the extension extends toward the one or more branches; and
b. an aeration device selected from the group consisting of an air diffuser and an air stone, wherein the aeration device is releasably connected to the air line extension.

17. The modular hydroponic system of claim 11, wherein the one or more receptacle sections comprise a fin upwardly disposed from an interior bottom surface of the one or more receptacle sections.

18. The modular hydroponic system of claim 11, wherein the manifold, the trunk, the one or more branches and one or more branch extensions are tubular components connected by a plurality of fastener systems, each fastener system comprising:
a. a gasket positioned between an abutment of the tubular components; and
b. two or more locking levers, each on opposite sides of each of the tubular components, each locking lever comprising a handle and a latch arm, wherein the handle is configured to engage with the latch arm to pull it closed as the handle is pushed against the tube,
wherein the first end of the trunk and the first end of the one or more branches have two or more connection points adjacent thereto, each connection point having an aperture for accommodating the locking lever handle, and wherein the second end of the trunk and the second end of the one or more branches have two or more protrusions adjacent thereto configured to be releasably engaged by a latch arm of the locking lever, wherein a catch at an end of the latch arms of the two or more locking levers is configured to releasably engage with the two or more protrusions, wherein when joined by the plurality of locking levers, the abutting tubes are sealingly engaged.

19. The modular hydroponic system of claim 11, wherein a cross section of the manifold, the trunk, and the one or more branches is oval.

20. A modular hydroponic system, comprising:
a. a reservoir;
b. a pump in communication with the reservoir;
c. a hose connection assembly having a hose end and a trunk end;
d. a hose, wherein one end of the hose is removably connected to the pump, and the opposite end of the hose is removably connected to the hose connection assembly's hose end, wherein the pump is configured to pump a liquid from the reservoir to the hose connection assembly through the hose;
e. a trunk having a first end and a second end, wherein the first end of the trunk is releasably connected to the trunk end of the hose connection assembly, wherein the trunk comprises:
i. one or more T-fitting sections; and
ii. an end cap releasably connected at the second end of the trunk, wherein the end cap is configured to close the second end of the trunk;
f. an air line integrated into an interior wall of the hose connection assembly and the trunk, the air line extending from the hose connection assembly through the trunk; and
g. one or more branches having a first end and a second end, wherein the first end of each of the one or more branches is releasably connected to one of the one or more T-fitting sections of the trunk, and wherein the one or more branches comprises one or more receptacle sections, wherein the one or more branches are downwardly sloped from the first end to the second end, wherein the second end is open and is in fluid communication with the reservoir.
